(19) United States
(12) Patent Application Publication
(10) Pub. No.: US 2025/0226618 A1
(43) Pub. Date: Jul. 10, 2025

(54) Electrical Connector

(71) Applicants: Dongguan Tarng Yu Electronics Co., Ltd., Dongguan City (CN); Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 19/006,951

(22) Filed: Dec. 31, 2024

(30) Foreign Application Priority Data
Jan. 5, 2024 (CN) 202420033720.7

(51) Int. Cl. H01R 13/6591; H01R 13/405; H01R 13/502; H01R 13/652

(52) U.S. Cl. CPC H01R 13/6591; H01R 13/405; H01R 13/502; H01R 13/652

(57) ABSTRACT

An electrical connector that can provide a shielding wall capable of transmitting shielded signals on at least three sides of the non-grounding conductive terminal, enabling to effectively reduce interference during high-speed signal transmission, thereby optimizing transmission quality for high-speed signals of the electrical connector, in order to meet the special requirements and development of electronic devices.”

### CROSS-REFERENCE TO RELATED APPLICATIONS

This application claims the priority of China Patent Application No. 202420033720.7 filed on Jan. 5, 2024, in the State Intellectual Property Office of China, the disclosure of which is incorporated herein by reference.

### BACKGROUND OF THE INVENTION

### Field of the Invention

This application relates to the technical field of electronic devices, and more specifically, it pertains to an electrical connector capable of reducing interference when transmitting high-speed signals.

### Descriptions of the Related Art

In recent years, electrical connectors have been widely used in various electronic devices to transmit signals through multiple conductive terminals on the electrical connectors. However, with the special requirements and development of electronic devices, the multiple conductive terminals of electrical connectors may also need to support high-speed signal transmission. Currently, electrical connectors are prone to interference during high-speed signal transmission (such interference may include electromagnetic interference from the external environment or crosstalk interference caused by coupling between multiple conductive terminals of the electrical connector). This results in interference and attenuation of the high-speed signals transmitted by the electrical connector.

As described above, how to solve the problem of interference during high-speed signal transmission in electrical connectors is an urgent issue to be addressed by those skilled in the art.

### SUMMARY OF THE INVENTION

In view of the drawbacks of the prior art mentioned above, the present application provides an electrical connector, one side of which is an electrical connector major side, comprising: a major-side conductive terminal assembly, positioned on the electrical connector major side, comprising a major-side first grounding conductive terminal, a major-side second grounding conductive terminal, and a major-side non-grounding conductive terminal; a major-side insulating terminal base, comprising a major-side first grounding terminal installation structure, a major-side second grounding terminal installation structure, and a major-side non-grounding terminal installation structure, wherein the major-side first grounding terminal installation structure provides installation for the major-side first grounding conductive terminal, the major-side second grounding terminal installation structure provides installation for the major-side second grounding conductive terminal, and the major-side non-grounding terminal installation structure provides installation for the major-side non-grounding conductive terminal, positioning the major-side non-grounding conductive terminal between the major-side first grounding conductive terminal and the major-side second grounding conductive terminal; and a conductive plastic base, providing support for the major-side insulating terminal base, and comprising a major-side conductive plastic base body, a major-side first conductive plastic wall structure, and a major-side second conductive plastic wall structure, and the major-side conductive plastic base body is electrically connected to the major-side first conductive plastic wall structure and the major-side second conductive plastic wall structure, and the major-side first conductive plastic wall structure abuts the major-side first grounding conductive terminal, and the major-side second conductive plastic wall structure abuts the major-side second grounding conductive terminal, enabling the conductive plastic base to be electrically connected to the major-side first grounding conductive terminal and the major-side second grounding conductive terminal, allowing the major-side conductive plastic base body, the major-side first conductive plastic wall structure, the major-side second conductive plastic wall structure, the major-side first grounding conductive terminal, and the major-side second grounding conductive terminal to form a major-side non-grounding terminal shielding wall, and the major-side non-grounding terminal shielding wall comprises a U-shaped cross-section, enabling the major-side non-grounding terminal shielding wall to provide a shielding wall on at least three sides of the major-side non-grounding conductive terminal.

Preferably, the electrical connector said above, wherein the front end of the electrical connector is an electrical connector joining front end, and the electrical connector further comprising a major-side front conductive connecting body, and the major-side front conductive connecting body extends from the electrical connector joining front end to span across the major-side non-grounding conductive terminal and is electrically connected to the major-side first grounding conductive terminal and the major-side second grounding conductive terminal, allowing the major-side front conductive connecting body to electrically connect to the major-side non-grounding terminal shielding wall, thereby providing electrical shielding for the major-side non-grounding conductive terminal at the electrical connector joining front end, wherein the major-side first grounding conductive terminal comprises a major-side first grounding terminal front joining structure, the major-side second grounding conductive terminal comprises a major-side second grounding terminal front joining structure, and the major-side non-grounding conductive terminal comprises a major-side non-grounding terminal front joining structure, and the major-side first grounding terminal front joining structure, the major-side second grounding terminal front joining structure, and the major-side non-grounding terminal front joining structure are respectively located at the electrical connector joining front end.

Preferably, the electrical connector said above, wherein the major-side front conductive connecting body comprises a major-side front wall shielding structure, and the major-side front wall shielding structure provides a shielding wall for the major-side non-grounding conductive terminal at the electrical connector joining front end.

Preferably, the electrical connector said above, wherein the major-side front conductive connecting body comprises a major-side front connector hollow structure, and the major-side front connector hollow structure is hollow and provides impedance matching for the major-side non-grounding conductive terminal at the electrical connector joining front end.

Preferably, the electrical connector said above, wherein the major-side conductive plastic base body extends along one side facing the major-side non-grounding conductive terminal.

Preferably, the electrical connector said above, wherein the major-side first grounding conductive terminal is inserted into the major-side first conductive plastic wall structure and the major-side second grounding conductive terminal is inserted into the major-side second conductive plastic wall structure, allowing the major-side first grounding conductive terminal and the major-side second grounding conductive terminal to be electrically connected to the conductive plastic base.

Preferably, the electrical connector said above, wherein the major-side first conductive plastic wall structure enters the major-side insulating terminal base to abut the major-side first grounding conductive terminal, and the major-side second conductive plastic wall structure enters the major-side insulating terminal base to abut the major-side second grounding conductive terminal.

Preferably, the electrical connector said above, wherein the major-side first conductive plastic wall structure abuts the major-side first grounding conductive terminal via surface contact, providing structural support to the major-side first grounding conductive terminal, and the major-side second conductive plastic wall structure abuts the major-side second grounding conductive terminal via surface contact, providing structural support to the major-side second grounding conductive terminal.

Preferably, the electrical connector said above, where the opposite side of the electrical connector is an electrical connector minor side, wherein the conductive plastic base further comprises a minor-side conductive plastic base body, a minor-side first conductive plastic wall structure, and a minor-side second conductive plastic wall structure, and the minor-side conductive plastic base body is electrically connected to the minor-side first conductive plastic wall structure and the minor-side second conductive plastic wall structure, and the electrical connector further comprises: a minor-side conductive terminal assembly, positioned on the electrical connector minor side and comprising a minor-side first grounding conductive terminal, a minor-side second grounding conductive terminal, and a minor-side non-grounding conductive terminal; a minor-side insulating terminal base, comprising a minor-side first grounding terminal installation structure, a minor-side second grounding terminal installation structure, and a minor-side non-grounding terminal installation structure, wherein the minor-side first grounding terminal installation structure provides installation for the minor-side first grounding conductive terminal, the minor-side second grounding terminal installation structure provides installation for the minor-side second grounding conductive terminal, and the minor-side non-grounding terminal installation structure provides installation for the minor-side non-grounding conductive terminal, positioning the minor-side non-grounding conductive terminal between the minor-side first grounding conductive terminal and the minor-side second grounding conductive terminal; wherein the conductive plastic base provides support for the minor-side insulating terminal base, and the minor-side first conductive plastic wall structure abuts the minor-side first grounding conductive terminal, and the minor-side second conductive plastic wall structure abuts the minor-side second grounding conductive terminal, allowing the conductive plastic base electrically to be connected to the minor-side first grounding conductive terminal and the minor-side second grounding conductive terminal, allowing the minor-side conductive plastic base body, the minor-side first conductive plastic wall structure, the minor-side second conductive plastic wall structure, the minor-side first grounding conductive terminal, and the minor-side second grounding conductive terminal to form a minor-side non-grounding terminal shielding wall, the minor-side non-grounding terminal shielding wall comprises a U-shaped cross-section, allowing the minor-side non-grounding terminal shielding wall to provide a shielding wall on at least three sides of the minor-side non-grounding conductive terminal.

Preferably, the electrical connector said above, wherein the front end of the electrical connector is an electrical connector joining front end, and the electrical connector further comprises a minor-side front conductive connecting body, the minor-side front conductive connecting body extends from the electrical connector joining front end and crosses over the minor-side non-grounding conductive terminal, and electrically connects the minor-side first grounding conductive terminal with the minor-side second grounding conductive terminal, allowing the minor-side front conductive connecting body to electrically connect the minor-side non-grounding terminal shielding wall, and provides electrical shielding for the minor-side non-grounding conductive terminal at the electrical connector joining front end; wherein the minor-side first grounding conductive terminal comprises a minor-side first grounding terminal front joining structure, the minor-side second grounding conductive terminal comprises a minor-side second grounding terminal front joining structure, and the minor-side non-grounding conductive terminal comprises a minor-side non-grounding terminal front joining structure, and the minor-side first grounding terminal front joining structure, the minor-side second grounding terminal front joining structure, and the minor-side non-grounding terminal front joining structure are respectively located at the electrical connector joining front end.

Preferably, the electrical connector said above, wherein the minor-side front conductive connecting body comprises a minor-side front wall shielding structure, the minor-side front wall shielding structure provides a shielding wall for the minor-side non-grounding conductive terminal at the electrical connector joining front end.

Preferably, the electrical connector said above, wherein the minor-side front conductive connecting body comprises a minor-side front connecting body hollow structure, and the minor-side front connector hollow structure is hollow and provides impedance matching for the minor-side non-grounding conductive terminal at the electrical connector joining front end.

Preferably, the electrical connector said above, wherein the minor-side conductive plastic base body extends along one side facing the minor-side non-grounding conductive terminal.

Preferably, the electrical connector said above, wherein the minor-side first grounding conductive terminal is inserted into the minor-side first conductive plastic wall structure and the minor-side second grounding conductive terminal is inserted into the minor-side second conductive plastic wall structure, allowing the minor-side first grounding conductive terminal and the minor-side second grounding conductive terminal to be electrically connected to the conductive plastic base.

Preferably, the electrical connector said above, wherein the minor-side first conductive plastic wall structure enters the minor-side insulating terminal base to abut the minor-side first grounding conductive terminal, and the minor-side second conductive plastic wall structure enters the minor-side insulating terminal base to abut the minor-side second grounding conductive terminal.

Preferably, the electrical connector said above, wherein the minor-side first conductive plastic wall structure abuts the minor-side first grounding conductive terminal via surface contact, providing structural support to the minor-side first grounding conductive terminal, and the minor-side second conductive plastic wall structure abuts the minor-side second grounding conductive terminal via surface contact, providing structural support to the minor-side second grounding conductive terminal.

Preferably, the electrical connector said above, wherein the major-side insulating terminal base and the minor-side insulating terminal base are respectively formable or formable as one piece.

Preferably, the electrical connector said above, wherein the major-side conductive plastic base body and the minor-side conductive plastic base body are respectively formable or formable as one piece.

In comparison to prior art, the electrical connector provided in this application can offer shielding walls capable of transmitting shielding signals on at least three sides of the non-grounding conductive terminals. In this way, it can effectively reduce interference when the electrical connector transmits high-speed signals, thereby optimizing the transmission quality of high-speed signals through the electrical connector to meet the special requirements and development of electronic devices.

### BRIEF DESCRIPTION OF THE DRAWINGS

The above and other aspects, comprises and other advantages of the present invention will be more clearly understood from the following detailed description taken in conjunction with the accompanying drawings, in which:

FIG. 1 is a three-dimension schematic view from a first angle of an embodiment of the electrical connector described in this application.

FIG. 2 is a three-dimension schematic view from a second angle of an embodiment of the electrical connector described in this application.

FIG. 3 is a top view schematic diagram of an embodiment of the electrical connector described in this application.

FIG. 4 is a cross-sectional schematic view of part of the electrical connector shown in FIG. 3, taken along line AA.

FIG. 5 is a cross-sectional schematic view of part of the electrical connector shown in FIG. 3, taken along line BB.

FIG. 6 is a cross-sectional schematic view of part of the electrical connector shown in FIG. 3, taken along line CC.

FIG. 7 is a cross-sectional schematic view of part of the electrical connector shown in FIG. 3, taken along line DD.

FIG. 8 is a three-dimension schematic view from a first angle of a part of the electrical connector described in this application in an embodiment.

FIG. 9 is a three-dimension schematic view from a second angle of a part of the electrical connector described in this application in an embodiment.

FIG. 10 is a three-dimension schematic view from a first angle of a part of the electrical connector described in this application in an embodiment.

FIG. 11 is a three-dimension schematic view from a second angle of a part of the electrical connector described in this application in an embodiment.

FIG. 12 is a three-dimension schematic view from a first angle of a part of the electrical connector described in this application in an embodiment.

FIG. 13 is a three-dimension schematic view from a second angle of a part of the electrical connector described in this application in an embodiment.

FIG. 14 is a three-dimension schematic view from a first angle of a part of the electrical connector described in this application in an embodiment.

FIG. 15 is a three-dimension schematic view from a second angle of a part of the electrical connector described in this application in an embodiment.

FIG. 16 is a three-dimension schematic view of a part of the electrical connector described in this application in an embodiment.

FIG. 17 is a three-dimension schematic view of a part of the electrical connector described in this application in an embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

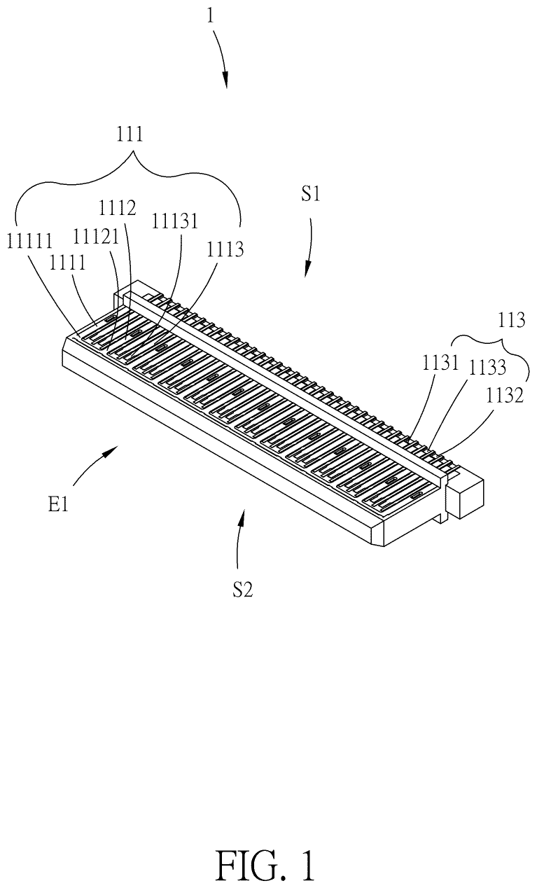

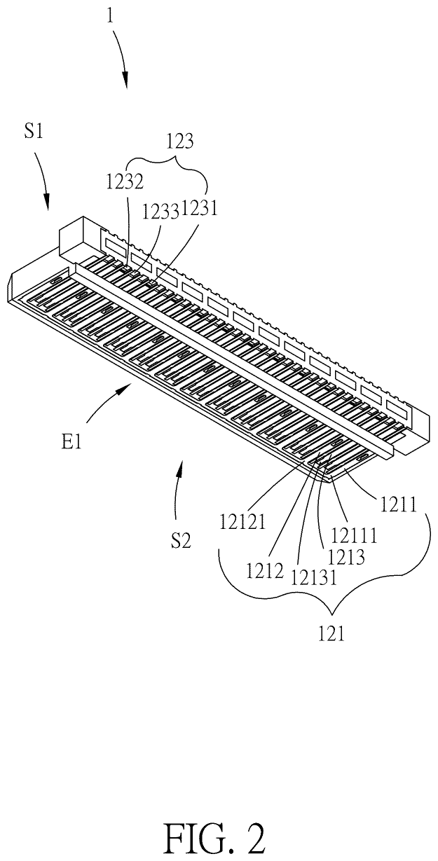

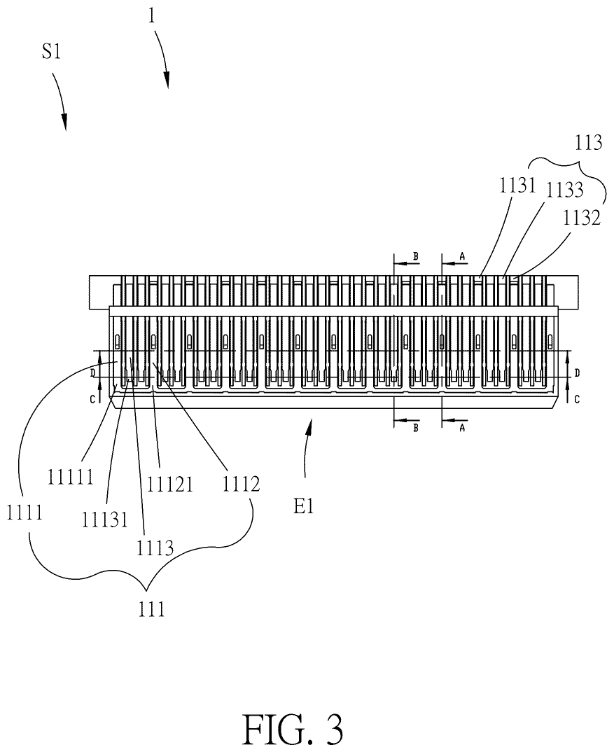

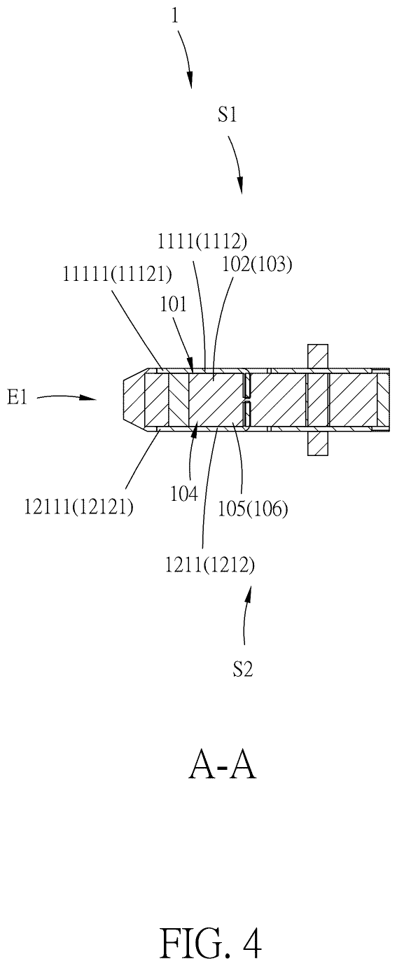

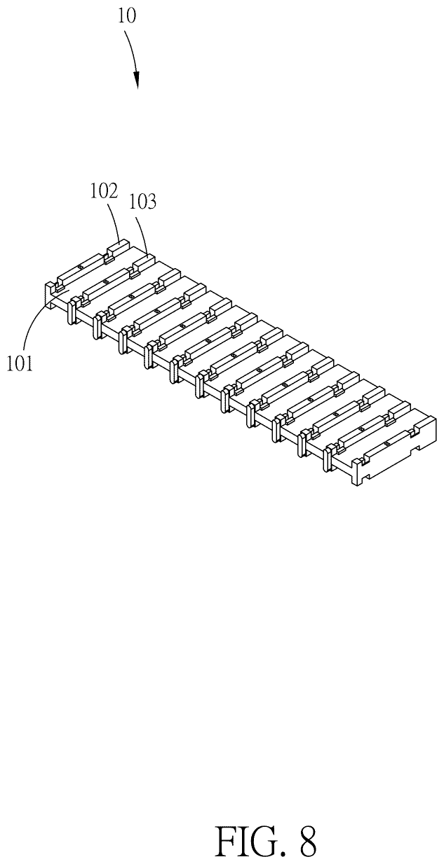

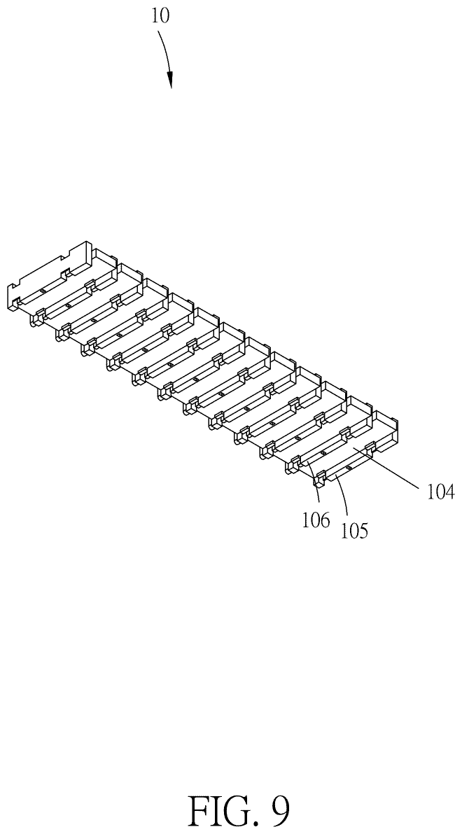

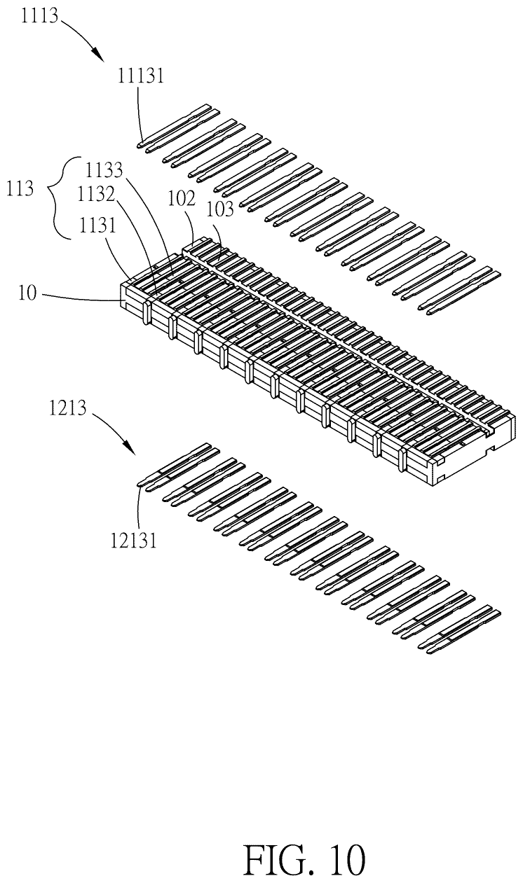

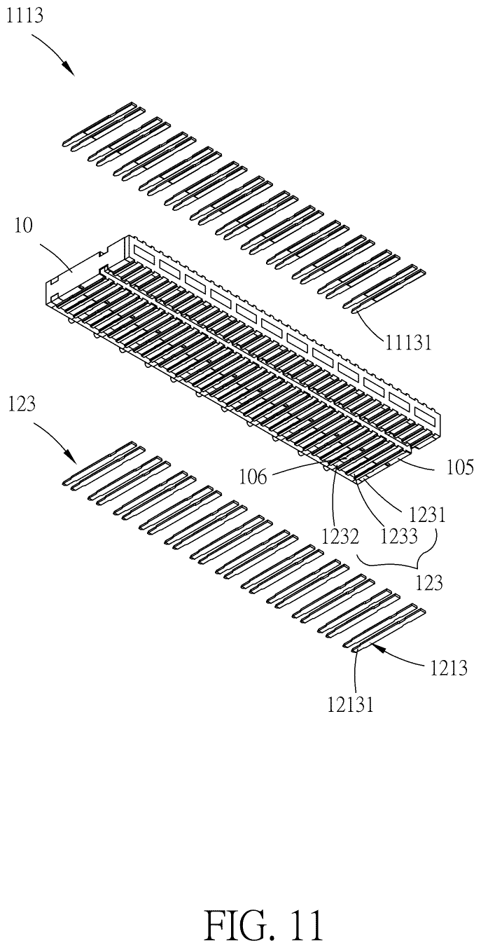

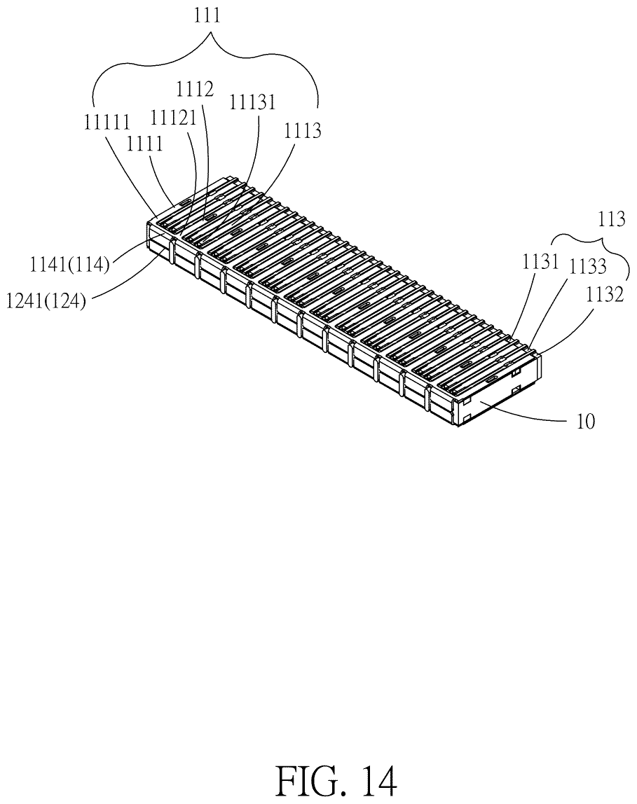

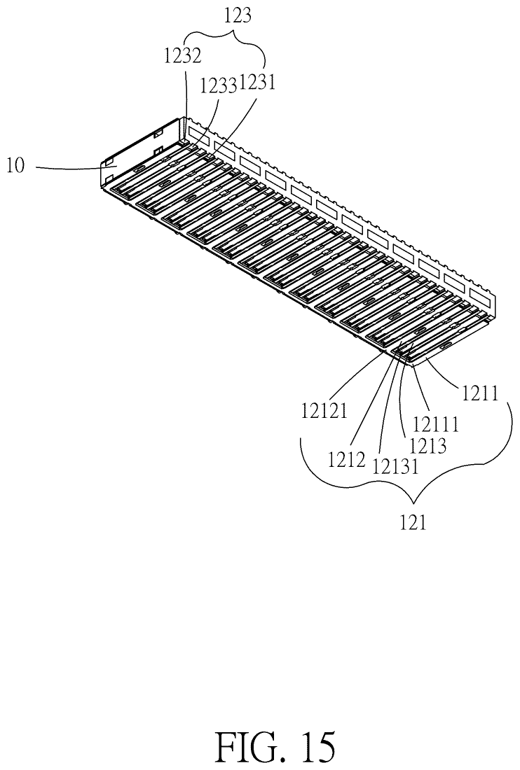

For a detailed description of the embodiments disclosed in the present application, please refer to FIGS. 1 to 17.

In the aforementioned embodiment, an electrical connector 1 is provided, which can be installed in an electronic device. In the electronic device, the electrical connector 1 can be joined with a front conductive component to provide signal transmission. Additionally, the two sides of the electrical connector 1 are respectively defined as an electrical connector major side S1 and an electrical connector minor side S2, while the front end of the electrical connector 1 is defined as the electrical connector joining front end E1.

It should be noted that, the electrical connector 1 can electrically connect the front conductive component on the electrical connector major side S1, the electrical connector minor side S2, and the electrical connector joining front end E1.

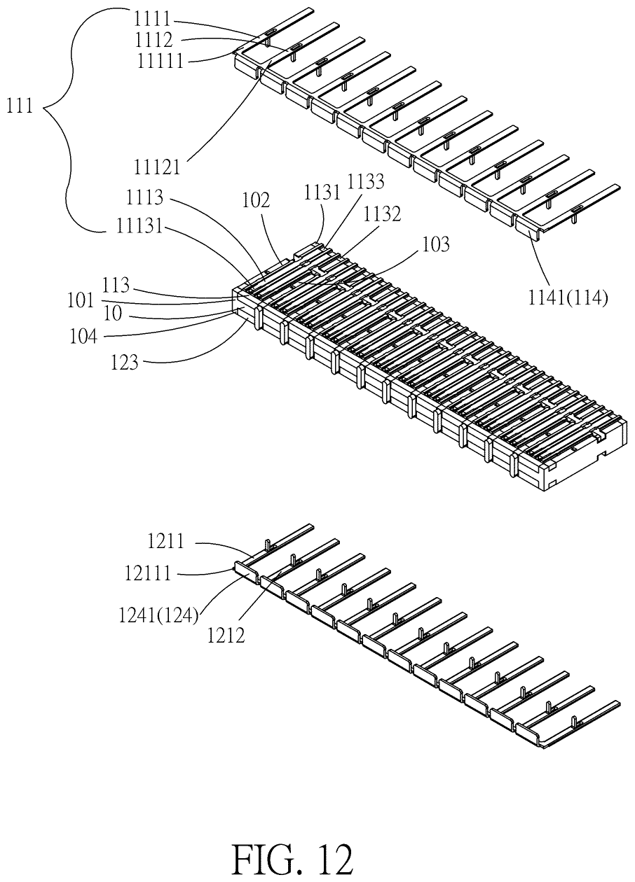

In the embodiment shown in FIGS. 12 to 15, the electrical connector 1 comprises a conductive plastic base 10, a major-side conductive terminal assembly 111, a minor-side conductive terminal assembly 121, a major-side insulating terminal base 113, a minor-side insulating terminal base 123, a major-side front conductive connecting body 114, and a minor-side front conductive connecting body 124.

It should be noted that the conductive plastic base 10 can be made of conductive plastic material and provide transmission of shielding signals, such as grounding signals. The major-side insulating terminal base 113 can be made of insulating material and provide positioning for the major-side conductive terminal assembly 111, and the minor-side insulating terminal base 123 can be made of insulating material and provide positioning for the minor-side conductive terminal assembly 121.

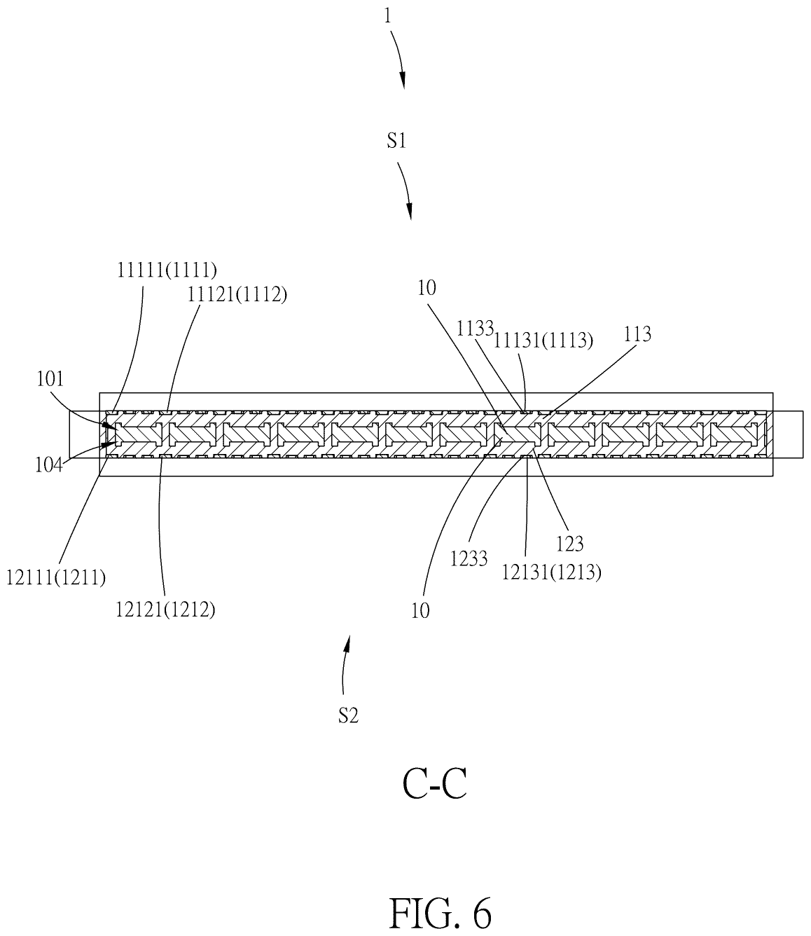

As shown in FIGS. 6 to 7 and FIGS. 12 to 13, the conductive plastic base 10 supports the major-side insulating terminal base 113 and the minor-side insulating terminal base 123. The conductive plastic base 10 comprises a major-side conductive plastic base body 101, a major-side first conductive plastic wall structure 102, a major-side second conductive plastic wall structure 103, a minor-side conductive plastic base body 104, a minor-side first conductive plastic wall structure 105, and a minor-side second conductive plastic wall structure 106.

It should be noted that, in this application, the major-side insulating terminal base 113 and the minor-side insulating terminal base 123 can be respectively formed or integrally formed. The major-side conductive plastic base body 101 and the minor-side conductive plastic base body 104 can also be respectively formed or integrally formed.

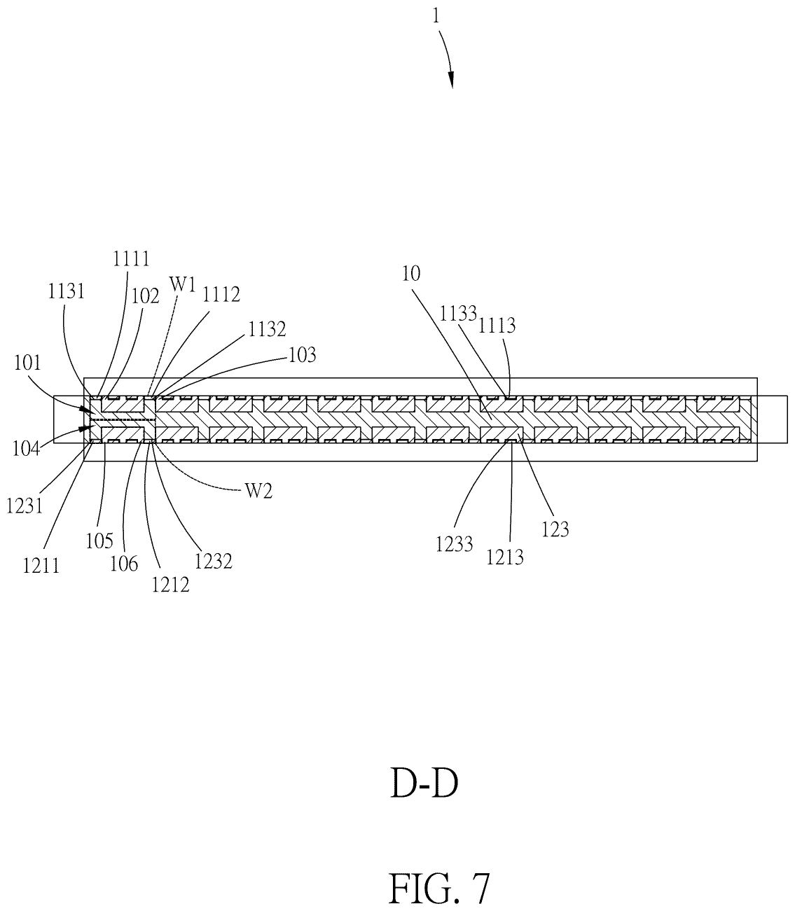

As shown in FIGS. 6 to 7, the major-side conductive terminal assembly 111 is located on the electrical connector major side S1 and comprises a major-side first grounding conductive terminal 1111, a major-side second grounding conductive terminal 1112, and a major-side non-grounding conductive terminal 1113. The minor-side conductive terminal assembly 121 is located on the electrical connector minor side S2 and comprises a minor-side first grounding conductive terminal 1211, a minor-side second grounding conductive terminal 1212, and a minor-side non-grounding conductive terminal 1213.

It should be noted that the major-side first grounding conductive terminal 1111, the major-side second grounding conductive terminal 1112, the minor-side first grounding conductive terminal 1211, and the minor-side second grounding conductive terminal 1212 can provide transmission of grounding signals. The number of the major-side first grounding conductive terminal 1111, the major-side second grounding conductive terminal 1112, the minor-side first grounding conductive terminal 1211, and the minor-side second grounding conductive terminal 1212 is not limited to one. The major-side non-grounding conductive terminal 1113 and the minor-side non-grounding conductive terminal 1213 can provide transmission of non-grounding signals, such as differential signals. The number of the major-side non-grounding conductive terminal 1113 and the minor-side non-grounding conductive terminal 1213 is also not limited to one.

In the embodiment shown in FIGS. 1, 3, 6 to 7, 12, 14, and 16, the major-side insulating terminal base 113 comprises a major-side first grounding terminal installation structure 1131, a major-side second grounding terminal installation structure 1132, and a major-side non-grounding terminal installation structure 1133. The major-side first grounding terminal installation structure 1131 installs the major-side first grounding conductive terminal 1111. The major-side second grounding terminal installation structure 1132 installs the major-side second grounding conductive terminal 1112. The major-side non-grounding terminal installation structure 1133 installs the major-side non-grounding conductive terminal 1113, making the major-side non-grounding conductive terminal 1113 located between the major-side first grounding conductive terminal 1111 and the major-side second grounding conductive terminal 1112.

It should be noted that the major-side first conductive plastic wall structure 102 abuts the major-side first grounding conductive terminal 1111, and the major-side second conductive plastic wall structure 103 abuts the major-side second grounding conductive terminal 1112. This allows the conductive plastic base 10 to electrically connect the major-side first grounding conductive terminal 1111 and the major-side second grounding conductive terminal 1112. The major-side conductive plastic base body 101, the major-side first conductive plastic wall structure 102, the major-side second conductive plastic wall structure 103, the major-side first grounding conductive terminal 1111, and the major-side second grounding conductive terminal 1112 form a major-side non-grounding terminal shielding wall W1. The major-side non-grounding terminal shielding wall W1 provides transmission of shielding signals, such as grounding signals, and comprises a U-shaped cross-section, allowing the major-side non-grounding terminal shielding wall W1 to provide shielding walls on at least three sides of the major-side non-grounding conductive terminal 1113 to create an electrically shielded environment for signal transmission of the major-side non-grounding conductive terminal 1113. This reduces interference during high-speed signal transmission of the electrical connector 1, thereby optimizing the transmission quality of high-speed signals and meeting the special needs and development of electronic devices.

Optionally, the major-side first conductive plastic wall structure 102 abuts the major-side first grounding conductive terminal 1111 in a surface contact manner, and the major-side second conductive plastic wall structure 103 abuts the major-side second grounding conductive terminal 1112 in a surface contact manner. This provides structural support for the major-side first grounding conductive terminal 1111 and the major-side second grounding conductive terminal 1112, reducing the degree of deformation caused by stress on the major-side first grounding conductive terminal 1111 and the major-side second grounding conductive terminal 1112.

As shown in FIGS. 6 to 7, 10, 12, and 16, the major-side conductive plastic base body 101 electrically connects the major-side first conductive plastic wall structure 102 and the major-side second conductive plastic wall structure 103, enabling the transmission of shielding signals, such as grounding signals. The major-side conductive plastic base body 101 extends toward one side facing the major-side non-grounding conductive terminal 1113, providing an electrically shielded environment for the signal transmission of the major-side non-grounding conductive terminal 1113.

Additionally, as shown in FIGS. 6 to 7, 12, and 16, the major-side first grounding conductive terminal 1111 is inserted into the major-side first conductive plastic wall structure 102, and the major-side second grounding conductive terminal 1112 is inserted into the major-side second conductive plastic wall structure 103, allowing the major-side first grounding conductive terminal 1111 and the major-side second grounding conductive terminal 1112 to electrically connect the conductive plastic base 10. As depicted in FIGS. 6 to 7, 10, 12, and 16, the major-side first conductive plastic wall structure 102 enters the major-side insulating terminal base 113, enabling to abut the major-side first grounding conductive terminal 1111, and the major-side second conductive plastic wall structure 103 enters the major-side insulating terminal base 113, enabling to abut the major-side second grounding conductive terminal 1112.

The major-side first grounding conductive terminal 1111 comprises a major-side first grounding terminal front joining structure 11111, the major-side second grounding conductive terminal 1112 comprises a major-side second grounding terminal front joining structure 11121, and the major-side non-grounding conductive terminal 1113 comprises a major-side non-grounding terminal front joining structure 11131. The major-side first grounding terminal front joining structure 11111, the major-side second grounding terminal front joining structure 11121, and the major-side non-grounding terminal front joining structure 11131 can respectively be joined with the front conductive component at the electrical connector joining front end E1 to provide the transmission of electrical signals.

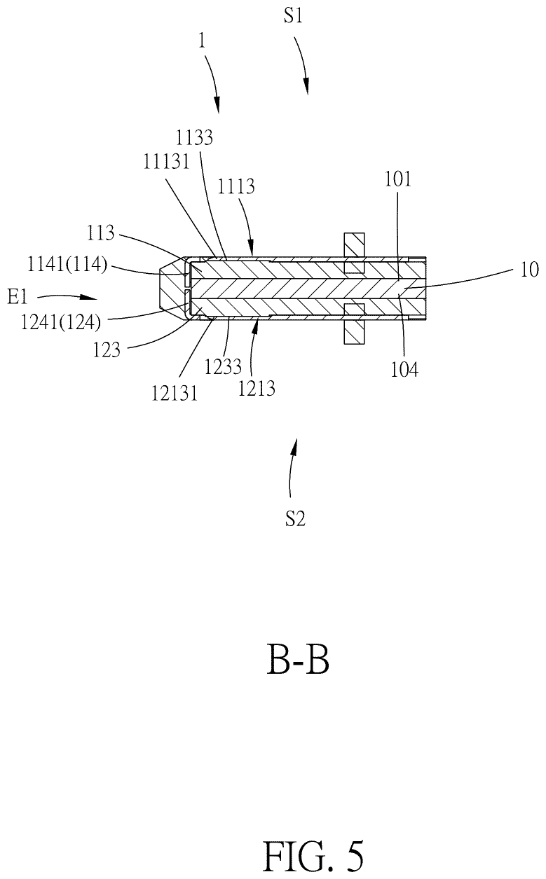

Additionally, as shown in FIGS. 5 and 7, the major-side front conductive connecting body 114 extends at the electrical connector joining front end E1, crosses over the major-side non-grounding conductive terminal 1113, and electrically connects the major-side first grounding conductive terminal 1111 and the major-side second grounding conductive terminal 1112. This configuration allows the major-side front conductive connecting body 114 to electrically connect the major-side non-grounding terminal shielding wall W1, thereby providing electrical shielding for the signal transmission of the major-side non-grounding conductive terminal 1113 at the electrical connector joining front end E1, reducing interference during high-speed signal transmission of the electrical connector 1, enhancing the transmission quality for high-speed signals of the electrical connector 1 and meeting the specialized needs and developments of electronic devices.

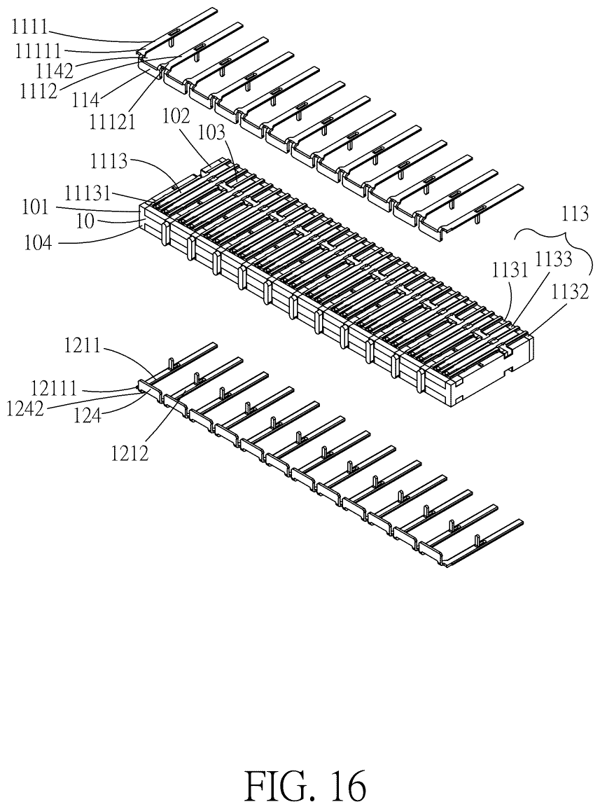

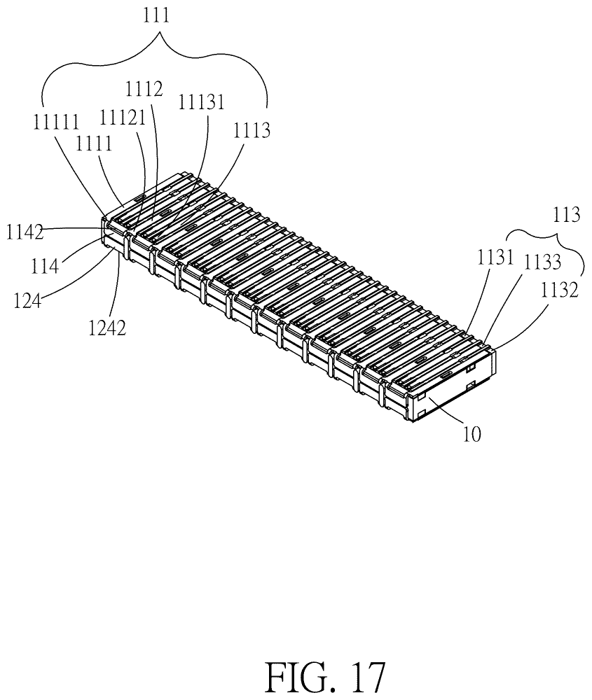

In the embodiment shown in FIGS. 5, 12, and 14, the major-side front conductive connecting body 114 comprises a major-side front wall shielding structure 1141. The major-side front wall shielding structure 1141 provides a shielding wall at the electrical connector joining front end E1, creating an electrically shielded environment for the signal transmission of the major-side non-grounding conductive terminal 1113. Alternatively, as shown in FIGS. 16 and 17, the major-side front conductive connecting body 114 comprises a major-side front connecting body hollow structure 1142. The major-side front connecting body hollow structure 1142 is hollow at the electrical connector joining front end E1 and provides impedance matching for the major-side non-grounding conductive terminal 1113.

In the embodiment shown in FIGS. 6 to 7, 13, and 15, the minor-side insulating terminal base 123 comprises a minor-side first grounding terminal installation structure 1231, a minor-side second grounding terminal installation structure 1232, and a minor-side non-grounding terminal installation structure 1233, wherein the minor-side first grounding terminal installation structure 1231 provides installation for the minor-side first grounding conductive terminal 1211, the minor-side second grounding terminal installation structure 1232 provides installation for the minor-side second grounding conductive terminal 1212, and the minor-side non-grounding terminal installation structure 1233 provides installation for the minor-side non-grounding conductive terminal 1213, allowing the minor-side non-grounding conductive terminal 1213 to be positioned between the minor-side first grounding conductive terminal 1211 and the minor-side second grounding conductive terminal 1212.

It should be noted that, the minor-side first conductive plastic wall structure 105 abuts the minor-side first grounding conductive terminal 1211, and the minor-side second conductive plastic wall structure 106 abuts the minor-side second grounding conductive terminal 1212, allowing the conductive plastic base 10 to electrically connect to the minor-side first grounding conductive terminal 1211 and the minor-side second grounding conductive terminal 1212, enabling the minor-side conductive plastic base body 104, the minor-side first conductive plastic wall structure 105, the minor-side second conductive plastic wall structure 106, the minor-side first grounding conductive terminal 1211, and the minor-side second grounding conductive terminal 1212 to form a minor-side non-grounding terminal shielding wall W2. The minor-side non-grounding terminal shielding wall W2 can provide transmission of shielding signals, such as grounding signals, and comprises a U-shaped cross-section, allowing the minor-side non-grounding terminal shielding wall W2 to provide shielding walls on at least three sides of the minor-side non-grounding conductive terminal 1213, thereby providing an electrical shielding environment for the signal transmission of the minor-side non-grounding conductive terminal 1213, thereby reducing the interference the electrical connector 1 encounters during high-speed signal transmission, and further optimizes the transmission quality of the electrical connector 1 for high-speed signals, thus meeting the specific needs and development of electronic devices.

Optionally, the minor-side first conductive plastic wall structure 105 abuts the minor-side first grounding conductive terminal 1211 in a surface-contact manner, providing structural support to minimize deformation of the minor-side first grounding conductive terminal 1211 under force, and the minor-side second conductive plastic wall structure 106 abuts the minor-side second grounding conductive terminal 1212 in a surface-contact manner, providing structural support to minimize deformation of the minor-side second grounding conductive terminal 1212 under force.

As shown in FIGS. 6 to 7, 11, and 13, the minor-side conductive plastic base body 104 electrically connects the minor-side first conductive plastic wall structure 105 and the minor-side second conductive plastic wall structure 106, transmitting shielding signals such as grounding signals. The minor-side conductive plastic base body 104 extends toward the side facing the minor-side non-grounding conductive terminal 1213, providing an electrically shielded environment for the signal transmission of the minor-side non-grounding conductive terminal 1213.

Additionally, as shown in FIGS. 6 to 7 and FIG. 13, the minor-side first grounding conductive terminal 1211 is inserted into the minor-side first conductive plastic wall structure 105, and the minor-side second grounding conductive terminal 1212 is inserted into the minor-side second conductive plastic wall structure 106, allowing the minor-side first grounding conductive terminal 1211 and the minor-side second grounding conductive terminal 1212 to be electrically connected to the conductive plastic base 10. As shown in FIGS. 6 to 7, FIG. 11, FIG. 13, and FIG. 15, the minor-side first conductive plastic wall structure 105 enters the minor-side insulating terminal base 123, and abut the minor-side first grounding conductive terminal 1211, and the minor-side second conductive plastic wall structure 106 enters the minor-side insulating terminal base 123, and abut the minor-side second grounding conductive terminal 1212.

The minor-side first grounding conductive terminal 1211 comprises a minor-side first grounding terminal front joining structure 12111, the minor-side second grounding conductive terminal 1212 comprises a minor-side second grounding terminal front joining structure 12121, and the minor-side non-grounding conductive terminal 1213 comprises a minor-side non-grounding terminal front joining structure 12131. The minor-side first grounding terminal front joining structure 12111, the minor-side second grounding terminal front joining structure 12121 and the minor-side non-grounding terminal front joining structure 12131 can respectively join with the front conductive component at the electrical connector joining front end E1 to provide electrical signal transmission.

Additionally, as shown in FIGS. 5 and 6, the minor-side front conductive connecting body 124 extends at the electrical connector joining front end E1, crossing over the minor-side non-grounding conductive terminal 1213 and electrically connecting the minor-side first grounding conductive terminal 1211 and the minor-side second grounding conductive terminal 1212. This configuration allows the minor-side front conductive connecting body 124 to electrically connect the minor-side non-grounding terminal shielding wall W2, providing electrical shielding for the minor-side non-grounding conductive terminal 1213 at the electrical connector joining front end E1, thus creating a shielding environment for signal transmission of the minor-side non-grounding conductive terminal 1213. This effectively reduces interference during the transmission of high-speed signals of the electrical connector 1, thereby optimizing transmission quality the electrical connector 1 to meet the special requirements and advancements in electronic devices.

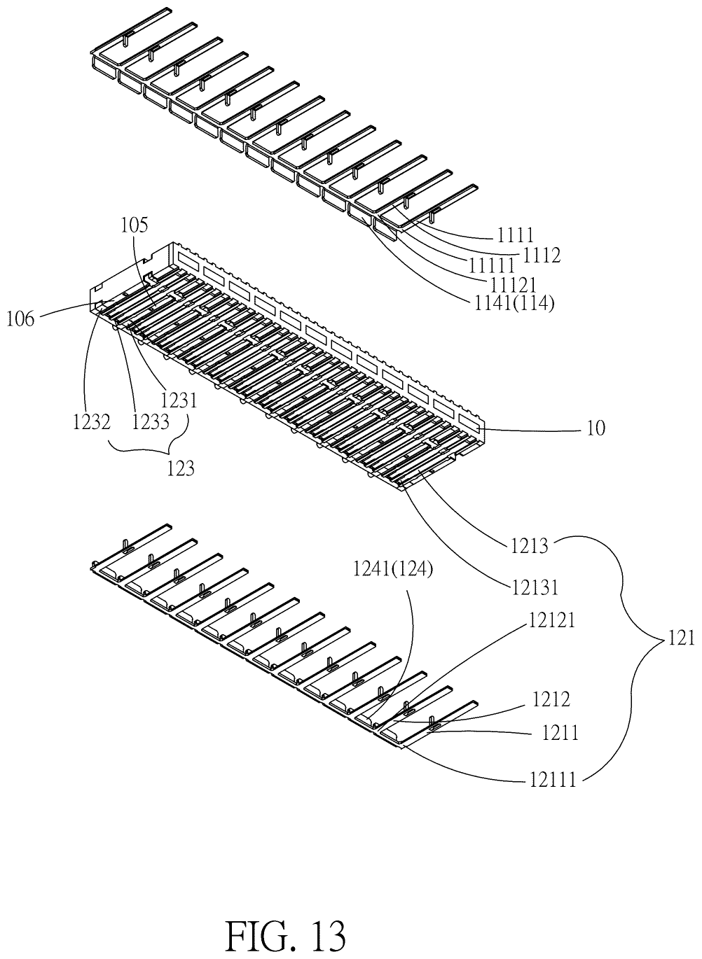

In the embodiment shown in FIGS. 5 and 13, the minor-side front conductive connecting body 124 comprises a minor-side front wall shielding structure 1241. The shielding structure 1241 provides a shielding wall for the minor-side non-grounding conductive terminal 1213 at the electrical connector joining front end E1, ensuring an electrically shielded environment for signal transmission of the major-side non-grounding conductive terminal 1113. However, this is not limited to the aforementioned structure. In the embodiment shown in FIGS. 16 and 17, the minor-side front conductive connecting body 124 comprises a minor-side front connecting body hollow structure 1242, and the minor-side front connecting body hollow structure 1242 is hollowed at the electrical connector joining front end E1 to provide impedance matching for the minor-side non-grounding conductive terminal 1213.

It should be noted that in the embodiments of this application, certain components may be omitted. For instance, the electrical connector can optionally include: a major-side conductive terminal assembly, a major-side insulating terminal base, and a conductive plastic base. The major-side conductive terminal assembly is located on the electrical connector major side and comprises a major-side first grounding conductive terminal, a major-side second grounding conductive terminal, and a major-side non-grounding conductive terminal. The major-side insulating terminal base comprises a major-side first grounding terminal installation structure, a major-side second grounding terminal installation structure, and a major-side non-grounding terminal installation structure. The major-side first grounding terminal installation structure installs the major-side first grounding conductive terminal, the major-side second grounding terminal installation structure installs the major-side second grounding conductive terminal, and the major-side non-grounding terminal installation structure installs the major-side non-grounding conductive terminal, placing the major-side non-grounding conductive terminal between the major-side first grounding conductive terminal and the major-side second grounding conductive terminal. The conductive plastic base supports the major-side insulating terminal base and comprises a major-side conductive plastic base body, a major-side first conductive plastic wall structure, and a major-side second conductive plastic wall structure. The major-side conductive plastic base body is electrically connected to the major-side first conductive plastic wall structure and the major-side second conductive plastic wall structure, the major-side first conductive plastic wall structure abuts the major-side first grounding conductive terminal, providing structural support for the major-side first grounding conductive terminal, and the major-side second conductive plastic wall structure abuts the major-side second grounding conductive terminal, providing structural support for the major-side second grounding conductive terminal, ensuring that the conductive plastic base electrically connects the major-side first grounding conductive terminal and the major-side second grounding conductive terminal. As a result, the major-side conductive plastic base body, the major-side first conductive plastic wall structure and the major-side second conductive plastic wall structure, the major-side first grounding conductive terminal and the major-side second grounding conductive terminal, and the major-side non-grounding terminal form a U-shaped shielding wall that provides shielding on at least three sides of the major-side non-grounding conductive terminal.

In summary, the electrical connector described in this application can provide shielding walls capable of transmitting shielding signals on at least three sides of the non-grounding conductive terminal. This effectively reduces interference during the transmission of high-speed signals, optimizing the transmission quality of the electrical connector to meet the special requirements and advancements in electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, one side of which is an electrical connector major side, comprising:
a major-side conductive terminal assembly, positioned on the electrical connector major side, comprising a major-side first grounding conductive terminal, a major-side second grounding conductive terminal, and a major-side non-grounding conductive terminal;
a major-side insulating terminal base, comprising a major-side first grounding terminal installation structure, a major-side second grounding terminal installation structure, and a major-side non-grounding terminal installation structure, wherein the major-side first grounding terminal installation structure provides installation for the major-side first grounding conductive terminal, the major-side second grounding terminal installation structure provides installation for the major-side second grounding conductive terminal, and the major-side non-grounding terminal installation structure provides installation for the major-side non-grounding conductive terminal, positioning the major-side non-grounding conductive terminal between the major-side first grounding conductive terminal and the major-side second grounding conductive terminal; and
a conductive plastic base, providing support for the major-side insulating terminal base, and comprising a major-side conductive plastic base body, a major-side first conductive plastic wall structure, and a major-side second conductive plastic wall structure, and the major-side conductive plastic base body is electrically connected to the major-side first conductive plastic wall structure and the major-side second conductive plastic wall structure, and the major-side first conductive plastic wall structure abuts the major-side first grounding conductive terminal, and the major-side second conductive plastic wall structure abuts the major-side second grounding conductive terminal, enabling the conductive plastic base to be electrically connected to the major-side first grounding conductive terminal and the major-side second grounding conductive terminal, allowing the major-side conductive plastic base body, the major-side first conductive plastic wall structure, the major-side second conductive plastic wall structure, the major-side first grounding conductive terminal, and the major-side second grounding conductive terminal to form a major-side non-grounding terminal shielding wall, and the major-side non-grounding terminal shielding wall comprises a U-shaped cross-section, enabling the major-side non-grounding terminal shielding wall to provide a shielding wall on at least three sides of the major-side non-grounding conductive terminal.

2. The electrical connector of claim 1, wherein the front end of the electrical connector is an electrical connector joining front end, and the electrical connector further comprising a major-side front conductive connecting body, and the major-side front conductive connecting body extends from the electrical connector joining front end to span across the major-side non-grounding conductive terminal and is electrically connected to the major-side first grounding conductive terminal and the major-side second grounding conductive terminal, allowing the major-side front conductive connecting body to electrically connect to the major-side non-grounding terminal shielding wall, thereby providing electrical shielding for the major-side non-grounding conductive terminal at the electrical connector joining front end, wherein the major-side first grounding conductive terminal comprises a major-side first grounding terminal front joining structure, the major-side second grounding conductive terminal comprises a major-side second grounding terminal front joining structure, and the major-side non-grounding conductive terminal comprises a major-side non-grounding terminal front joining structure, and the major-side first grounding terminal front joining structure, the major-side second grounding terminal front joining structure, and the major-side non-grounding terminal front joining structure are respectively located at the electrical connector joining front end.

3. The electrical connector of claim 2, wherein the major-side front conductive connecting body comprises a major-side front wall shielding structure, and the major-side front wall shielding structure provides a shielding wall for the major-side non-grounding conductive terminal at the electrical connector joining front end.

4. The electrical connector of claim 2, wherein the major-side front conductive connecting body comprises a major-side front connector hollow structure, and the major-side front connector hollow structure is hollow and provides impedance matching for the major-side non-grounding conductive terminal at the electrical connector joining front end.

5. The electrical connector of claim 1, wherein the major-side conductive plastic base body extends along one side facing the major-side non-grounding conductive terminal.

6. The electrical connector of claim 1, wherein the major-side first grounding conductive terminal is inserted into the major-side first conductive plastic wall structure and the major-side second grounding conductive terminal is inserted into the major-side second conductive plastic wall structure, allowing the major-side first grounding conductive terminal and the major-side second grounding conductive terminal to be electrically connected to the conductive plastic base.

7. The electrical connector of claim 1, wherein the major-side first conductive plastic wall structure enters the major-side insulating terminal base to abut the major-side first grounding conductive terminal, and the major-side second conductive plastic wall structure enters the major-side insulating terminal base to abut the major-side second grounding conductive terminal.

8. The electrical connector of claim 1, wherein the major-side first conductive plastic wall structure abuts the major-side first grounding conductive terminal via surface contact, providing structural support to the major-side first grounding conductive terminal, and the major-side second conductive plastic wall structure abuts the major-side second grounding conductive terminal via surface contact, providing structural support to the major-side second grounding conductive terminal.

9. The electrical connector of claim 1, where the opposite side of the electrical connector is an electrical connector minor side, wherein the conductive plastic base further comprises a minor-side conductive plastic base body, a minor-side first conductive plastic wall structure, and a minor-side second conductive plastic wall structure, and the minor-side conductive plastic base body is electrically connected to the minor-side first conductive plastic wall structure and the minor-side second conductive plastic wall structure, and the electrical connector further comprises:
a minor-side conductive terminal assembly, positioned on the electrical connector minor side and comprising a minor-side first grounding conductive terminal, a minor-side second grounding conductive terminal, and a minor-side non-grounding conductive terminal;
a minor-side insulating terminal base, comprising a minor-side first grounding terminal installation structure, a minor-side second grounding terminal installation structure, and a minor-side non-grounding terminal installation structure, wherein the minor-side first grounding terminal installation structure provides installation for the minor-side first grounding conductive terminal, the minor-side second grounding terminal installation structure provides installation for the minor-side second grounding conductive terminal, and the minor-side non-grounding terminal installation structure provides installation for the minor-side non-grounding conductive terminal, positioning the minor-side non-grounding conductive terminal between the minor-side first grounding conductive terminal and the minor-side second grounding conductive terminal; wherein
the conductive plastic base provides support for the minor-side insulating terminal base, and the minor-side first conductive plastic wall structure abuts the minor-side first grounding conductive terminal, and the minor-side second conductive plastic wall structure abuts the minor-side second grounding conductive terminal, allowing the conductive plastic base electrically to be connected to the minor-side first grounding conductive terminal and the minor-side second grounding conductive terminal, allowing the minor-side conductive plastic base body, the minor-side first conductive plastic wall structure, the minor-side second conductive plastic wall structure, the minor-side first grounding conductive terminal, and the minor-side second grounding conductive terminal to form a minor-side non-grounding terminal shielding wall, the minor-side non-grounding terminal shielding wall comprises a U-shaped cross-section, allowing the minor-side non-grounding terminal shielding wall to provide a shielding wall on at least three sides of the minor-side non-grounding conductive terminal.

10. The electrical connector of claim 9, wherein the front end of the electrical connector is an electrical connector joining front end, and the electrical connector further comprises a minor-side front conductive connecting body, the minor-side front conductive connecting body extends from the electrical connector joining front end and crosses over the minor-side non-grounding conductive terminal, and electrically connects the minor-side first grounding conductive terminal and the minor-side second grounding conductive terminal, allowing the minor-side front conductive connecting body to electrically connect the minor-side non-grounding terminal shielding wall, and provides electrical shielding for the minor-side non-grounding conductive terminal at the electrical connector joining front end; wherein the minor-side first grounding conductive terminal comprises a minor-side first grounding terminal front joining structure, the minor-side second grounding conductive terminal comprises a minor-side second grounding terminal front joining structure, and the minor-side non-grounding conductive terminal comprises a minor-side non-grounding terminal front joining structure, and the minor-side first grounding terminal front joining structure, the minor-side second grounding terminal front joining structure, and the minor-side non-grounding terminal front joining structure are respectively located at the electrical connector joining front end.

11. The electrical connector of claim 10, wherein the minor-side front conductive connecting body comprises a minor-side front wall shielding structure, the minor-side front wall shielding structure provides a shielding wall for the minor-side non-grounding conductive terminal at the electrical connector joining front end.

12. The electrical connector of claim 10, wherein the minor-side front conductive connecting body comprises a minor-side front connecting body hollow structure, and the minor-side front connector hollow structure is hollow and provides impedance matching for the minor-side non-grounding conductive terminal at the electrical connector joining front end.

13. The electrical connector of claim 9, wherein the minor-side conductive plastic base body extends along one side facing the minor-side non-grounding conductive terminal.

14. The electrical connector of claim 9, wherein the minor-side first grounding conductive terminal is inserted into the minor-side first conductive plastic wall structure and the minor-side second grounding conductive terminal is inserted into the minor-side second conductive plastic wall structure, allowing the minor-side first grounding conductive terminal and the minor-side second grounding conductive terminal to be electrically connected to the conductive plastic base.

15. The electrical connector of claim 9, wherein the minor-side first conductive plastic wall structure enters the minor-side insulating terminal base to abut the minor-side first grounding conductive terminal, and the minor-side second conductive plastic wall structure enters the minor-side insulating terminal base to abut the minor-side second grounding conductive terminal.

16. The electrical connector of claim 9, wherein the minor-side first conductive plastic wall structure abuts the minor-side first grounding conductive terminal via surface contact, providing structural support to the minor-side first grounding conductive terminal, and the minor-side second conductive plastic wall structure abuts the minor-side second grounding conductive terminal via surface contact, providing structural support to the minor-side second grounding conductive terminal.

17. The electrical connector of claim 9, wherein the major-side insulating terminal base and the minor-side insulating terminal base are respectively formable or formable as one piece.

18. The electrical connector of claim 9, wherein the major-side conductive plastic base body and the minor-side conductive plastic base body are respectively formable or formable as one piece.
